(19) United States
(12) Patent Application Publication
(10) Pub. No.: US 2016/0059827 A1
(43) Pub. Date: Mar. 3, 2016

(54) OPTIMIZING UWB SATELLITE ANTENNA IN-VEHICLE POSITIONING

(71) Applicant: LEAR CORPORATION, Southfield, MI (US)

(72) Inventors: Nizam UDDIN, West Bloomfield, MI (US); Thomas O'BRIEN, Troy, MI (US); Jason BAUMAN, Birmingham, MI (US)

(21) Appl. No.: 14/833,664

(22) Filed: Aug. 24, 2015

Related U.S. Application Data
(60) Provisional application No. 62/042,522, filed on Aug. 27, 2014.

(51) Int. Cl. B60R 25/24; H04B 7/04; G01S 5/02; B62D 25/10; E05F 15/77; H04B 1/7163; B60R 25/20

(52) U.S. Cl. CPC B60R 25/245; H04B 1/71637; H04B 7/0404; B60R 25/209; B62D 25/10; E05F 15/77; G01S 5/0284; H04B 2201/71632

(57) ABSTRACT

An electronic passive entry-passive start (ePEPS) system includes a first satellite ultra-wideband antenna, a second satellite ultra-wideband antenna, a third satellite ultra-wideband antenna, and a fourth satellite ultra-wideband antenna. A remote function actuator is in electronic communication with the first satellite ultra-wideband antenna, the second satellite ultra-wideband antenna, the third satellite ultra-wideband antenna, and the fourth satellite ultra-wideband antenna. A body control module can be in electronic communication with remote function actuator. A key fob is in wireless communication with the first satellite ultra-wideband antenna, the second satellite ultra-wideband antenna, the third satellite ultra-wideband antenna, and the fourth satellite ultra-wideband antenna such that predetermined functions in a vehicle are actuated depending on the position of a user.

### CROSS-REFERENCE TO RELATED APPLICATIONS

This application claims the benefit of U.S. provisional application Ser. No. 62/042,522 filed Aug. 27, 2014, the disclosure of which is hereby incorporated in its entirety by reference herein.

### TECHNICAL FIELD

The present invention is related to electronic passive entry-passive start systems.

### BACKGROUND

Customer demand increasingly provides an impetus for automobile manufacturers to incorporate enhanced features. Electronic passive entry-passive start system (ePEPS) is an example of such an enhanced feature. Additional improvements in ePEPS system technology are possible and are even being requested by the consumer. The problem of fumbling for the existing active remote keyless entry-start fob while standing in the rain or when in an emergency situation has provided the motivation to design and implement an ePEPS system.

Existing electronic passive entry-passive start systems can cause unintentional lock actuations when the consumer is in the near vicinity of the vehicle and does not wish to unlock the vehicle (“false alarms”). False alarms present an additional drain on the vehicle and FOB batteries, prematurely reducing the operating life of the locking system. They can also present a security issue if the false alarm leaves the doors unlocked.

Accordingly, there is a need for improved passive electronic passive entry-passive start systems with improved reliability.

### SUMMARY

The present invention solves one or more problems of the prior art by providing, in at least one embodiment, an electronic passive entry-passive start (ePEPS) system. The electronic passive entry-passive start system includes a first satellite ultra-wideband antenna positioned within or on a vehicle, a second satellite ultra-wideband antenna positioned within or on a vehicle, a third satellite ultra-wideband antenna positioned within or on a vehicle, and a fourth satellite ultra-wideband antenna positioned within or on a vehicle. A remote function actuator is in electronic communication with the first satellite ultra-wideband antenna, the second satellite ultra-wideband antenna, the third satellite ultra-wideband antenna, and the fourth satellite ultra-wideband antenna. A body control module can be in electronic communication with remote function actuator. A key fob is wireless communication with the first satellite ultra-wideband antenna, the second satellite ultra-wideband antenna, the third satellite ultra-wideband antenna, and the fourth satellite ultra-wideband antenna such that predetermined functions in a vehicle are actuated depending on the position of a user.

In another embodiment, the electronic passive entry-passive start (ePEPS) system operates such that the first satellite ultra-wideband antenna, second satellite ultra-wideband antenna, third satellite ultra-wideband antenna, fourth satellite ultra-wideband antenna, and the key fob transmit and/or receive a signal in the range of 3 kHz to 300 GHz and such that the first satellite ultra-wideband antenna, second satellite ultra-wideband antenna, third satellite ultra-wideband antenna, fourth satellite ultra-wideband antenna, and the key fob transmit and/or receive a signal with a bandwidth greater than or equal to 500 MHz or 20% of a center frequency.

Advantageously, the ePEPS system allows hands free unlocking, locking of the vehicle doors and engine starting with a push of a button, without the need to use a physical key fob. The ePEPS system provides the means to detect the approach and presence of a key fob in and around the vehicle space by driving Ultra Wide Band (UWB) antennas in the vehicle. Based on the fob's location and approach, the base station will unlock or lock doors, open the trunk, or allow starting of the vehicle at the push of a button on the vehicle's instrument panel.

To detect the smart Key Fob with approach and exact 3D (3-Dimensional) location (in-cabin or outside vehicle), typically four active satellite active antennas (SAT) are installed in-cabin vehicle. The packaging locations of these SATs should preferably follow certain guidelines to achieve optimum precision.

### BRIEF DESCRIPTION OF THE DRAWINGS

FIG. 1 provides a schematic illustration of an electronic passive entry-passive start (ePEPS) system;

FIG. 2 provides a schematic illustration showing actuation zones established by the satellite ultra-wideband antenna anchors;

FIG. 3A is a side view showing the placement of satellite ultra-wideband antenna anchors within a vehicle;

FIG. 3B is a top view showing the placement of satellite ultra-wideband antenna anchors within a vehicle;

FIG. 4A is a top view showing the placement of satellite ultra-wideband antenna anchors within a vehicle; and

FIG. 4B is a top view showing the placement of satellite ultra-wideband antenna anchors within a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary, the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments and is not intended to be limiting in any way.

It must also be noted that the singular form “a”, “an”, and “the” comprise plural referents unless the context clearly indicates otherwise. For example, reference to a component in the singular is intended to comprise a plurality of components.

Throughout this application, where publications are referenced, the disclosures of these publications are hereby incorporated by reference into this application in their entirety to more fully describe the state of the art to which this invention pertains.

### Abbreviations:

“ePEPS” means electronic passive entry-passive start;

“GHz” means gigahertz;

“MHz” means megahertz;

“UWB” means ultra wide band;

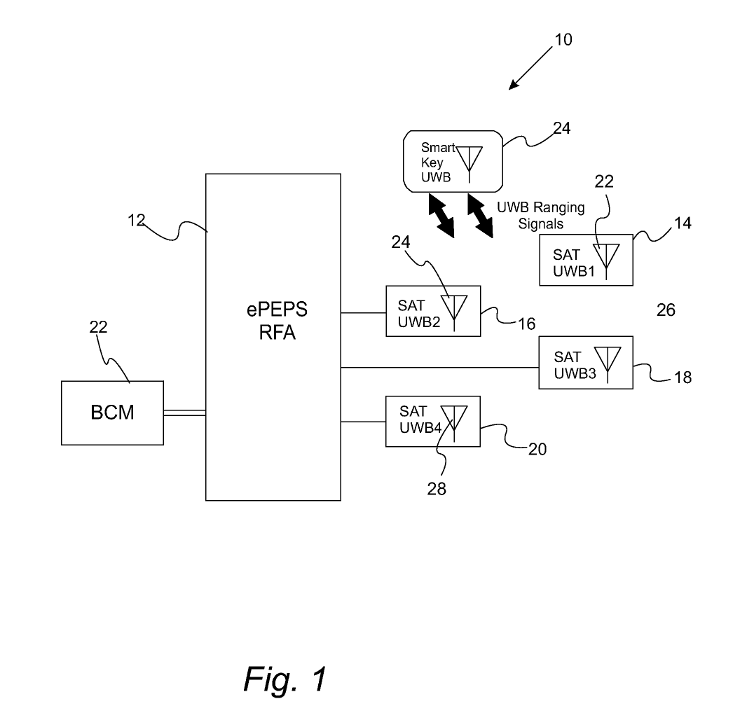

With reference to FIG. 1, a schematic illustration of an electronic passive entry-passive start (ePEPS) system is provided. In a variation, ePEPS system 10 includes remote function actuator 12 in electronic communication with satellite ultra-wideband antenna anchors 14, 16, 18, 20. The satellite ultra-wideband antenna anchors each respectively include satellite ultra-wideband antennas 22, 24, 26, 28 mounted therein. Body control module 32, which controls various functions such as vehicle locking and unlocking and vehicle interior lighting, is also in electronic communication with remote function actuator 12. Key fob 34 is in wireless communication (e.g., radio communication) with satellite ultra-wideband antennas 22, 24, 26, 28.

In a variation, the term “ultra-wideband” refers to a wireless communication technology in which information and, in particular, digital data is transmitted over a wide spectrum of frequency bands by generating radio energy at specific time intervals. Ultra-wideband uses a large bandwidth thereby allowing pulse-position or time modulation. Although the present embodiment is not limited to any particular frequencies, ultra-wideband is a radio technology typically using narrow or short pulses operating in the range of 3 kHz to 300 GHz (e.g., the center frequency). In a refinement, the ultra-wideband antennas 22, 24, 26, 28 and key fob transmit and/or receive a signal (e.g., data) over a short distance, usually less than about 300 feet. In a variation, ultra-wideband has a bandwidth that covers a plurality of octaves. Typically, ultra-wideband antennas 22, 24, 26, 28 and key fob 34 transmit and/or receive a signal with a bandwidth greater than or equal to 500 MHz or 20% of the center frequency. In a refinement, ultra-wideband antennas 22, 24, 26, 28 and key fob 34 transmit and/or receive a signal with a bandwidth from about 500 MHz to about 20 GHz. In another refinement, ultra-wideband antennas 22, 24, 26, 28 and key fob 34 transmit and/or receive a signal with a bandwidth from about 500 MHz to about 4 GHz. In still another refinement, ultra-wideband antennas 22, 24, 26, 28 and key fob 34 transmit and/or receive a signal with a bandwidth from about 2 GHz to about 18 GHz. In many applications, the power spectral density emission limit for ultra-wideband transmission is Δ41.3 dBm/MHz. Additional features regarding UWB technology are found in hraunfossfcc.gov/edocs_public/attachmatch/FCC-02-48A1.pdf and in A. K. Thakre and A. I. Dhenge, International Journal of Advanced Research in Computer and Communication Engineering, Vol. 1, Issue 9, November 2012, pages 683-686; the entire disclosures of which are hereby incorporated by reference.

One feature of the present embodiment involves the proper placement of satellite ultra-wideband antenna anchors 14, 16, 18, 20 and therefore, ultra-wideband antennas 22, 24, 26, 28 within a vehicle (i.e. the interior of a vehicle). In particular, satellite ultra-wideband antenna anchors 14, 16, 18, 20 should be as far as possible from each other with respect to axis system (e.g., the X-Y axes) in a plane parallel to the vehicle floor. In a refinement, a separation of about 1 meter or more between the antenna anchors is provided. At least one ultra-wideband antenna anchor should have maximum separation from the other anchors with respect to an axis (e.g., Z axis perpendicular to a plane parallel to a vehicle floor. Satellite ultra-wideband antenna anchors 14, 16, 18, 20 and therefore, ultra-wideband antennas 22, 24, 26, 28 should not be surrounded or enclosed by metal/objects on more than one side. Near the edge of body/metal sheet, the flat base of the satellite ultra-wideband antenna anchors 14, 16, 18, 20 and therefore, ultra-wideband antennas 22, 24, 26, 28 should be facing the sheet/body metal. The satellite ultra-wideband antenna anchors 14, 16, 18, 20 and therefore, ultra-wideband antennas 22, 24, 26, 28 should be near a corner/end of the metal/body sheet, close to and/or in view of glass. Finally, satellite ultra-wideband antenna anchors 14, 16, 18, 20 and therefore, ultra-wideband antennas 22, 24, 26, 28 face outwards from car-body sheet metal.

It should be noted that the above guidelines are difficult to achieve because of packaging restrictions in vehicles. For example, the pillar (and around pillar) locations are restricted because of airbag use. The two packaging locations suggested below are practically possible in a vehicle and the suggestion is based on several studies done at Lear Corporation facilities and successfully implemented on ePEPS experimental project.

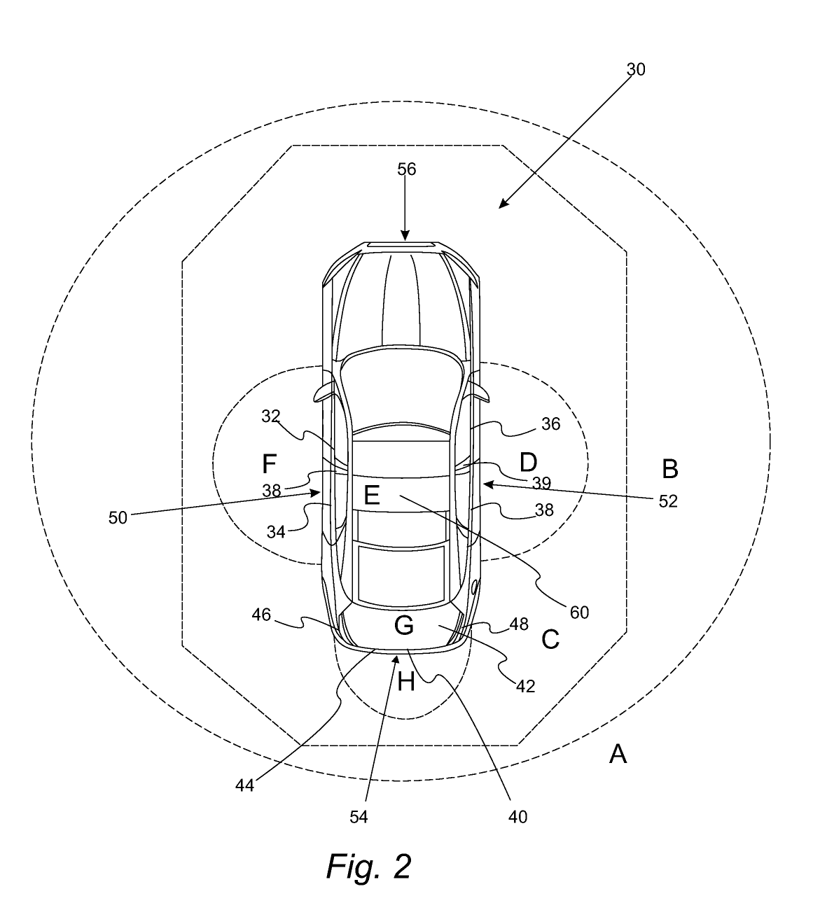

With reference to FIG. 2, a schematic illustration showing actuation zones established by the satellite ultra-wideband antennas of FIG. 1 is provided. The ePEP system of FIG. 1 is mounted in vehicle 30. A user (with valid key fob) entering zone D or F, results in ePEPS system 10 unlocking all vehicle doors, or some doors depending upon the user setting. Zones D and F are defined as the area adjacent to vehicle doors 32, 34, 36, and 38. In a refinement, ePEPS system 10 unlocks at least one of, or all of, vehicle doors 32, 34, 36, and 38 if the user is within a first predefined distance of the B-pillar or a vehicle door. In another refinement, ePEPS system 10 unlocks at least one of, or all of, vehicle doors 32, 34, 36, and 38 if the user is within 10 feet of the B-pillar 48 or passenger doors 32, 34, 36, and 38. In another refinement, ePEPS system 10 unlocks at least one of, or all of, vehicle doors 32, 34, 36, and 38 if the user is within 15 feet of the B-pillar 48 or passenger door 32, 34, 36, and 38. In other refinements, ePEPS system 10 unlocks at least one of, or all of, vehicle doors 32, 34, 36, and 38 if the user is within, in increasing order of preference, 30 feet, 20 feet, 15 feet, 10 feet, or 5 feet of the B-pillar 48 or passenger door 32, 34, 36, and 38.

Still referring to FIGS. 1 and 2, a user (with valid Key Fob) entering zone H results in ePEPS system 10 unlocking the trunk. Zone H is defined as a region in the vicinity of a vehicle trunk that is within a second predefined distance of the center 40 of the vehicle trunk 42. In this context, the center 40 of the vehicle trunk is a point on the rear edge 44 of the trunk that is equidistance from the opposite sides 46, 48 of the trunk between which the rear edge 44 is positioned. In a variation, ePEPS system 10 unlocks the trunk when the user is within a second predefined distance of the center of the vehicle trunk 40. In a refinement, the second predefined distance is less than the first predefined distance. In another refinement, the system unlock the trunk when the user is within 10 feet of the center of the vehicle trunk 40. In another refinement, ePEPS system 10 unlocks the trunk when the user is within 5 feet of the center of the vehicle trunk 42. In another refinement, ePEPS system 10 unlocks the trunk when the user is within 3 feet of the center of the vehicle trunk 40. In other refinements, ePEPS system 10 unlocks the trunk if the user is within, in increasing order of preference, 10 feet, 5 feet, 4 feet, 3 feet, or 2 feet of the center of the vehicle trunk.

Still referring to FIG. 2, a user with valid key fob leaving the vehicle crossing zone C into zone B locks the vehicle. Zone C is defined as the region within a third predetermined distance from sides 50, 52 and back 54 and front 56 of vehicle 30 excluding the regions of zones F, D, and H. Therefore, ePEPS system 10 locks the vehicle when a user with the key fob crosses from a distance less than a third predefined distance to a distance greater than the third predefined distance. Zone B is defined as the region within a fourth predetermined distance of a vehicle center 60 excluding regions C, D, F, and H. In this context, the vehicle center 60 is a point that is equidistant from the sides of the vehicle, equidistant from the front and rear of the vehicle, and equidistant from the top and bottom of the vehicle. The third predetermined distance is greater than the first and second predetermined distances. The fourth predetermined distance is greater than the third predetermined distance such that zone B is always more distant from the vehicle than zone C. In a refinement, the third predetermined distance is 10 feet. In another refinement, the third predetermined distance is 20 feet. In other refinement, the third predetermined distance is, in increasing order of preference 5 feet, 10 feet, 15 feet, 20 feet, or 25 feet. In a refinement, the fourth predetermined distance is 12 feet. In another refinement, the third predetermined distance is 25 feet. In other refinement, the third predetermined distance is, in increasing order of preference 10 feet, 12 feet, 15 feet, 25 feet, or 30 feet.

Still referring to FIG. 2, zone A provides the maximum range of the Fob communication to the vehicle. Therefore, the maximum range is at a fifth predetermined distance from the vehicle center 60. The fifth predetermined distance is greater than the first, second, third or fourth distances. In a refinement, the fifth distance is less than or equal to 50 feet. In another refinement, the fifth distance is less than or equal to 30 feet. In other refinements, the fifth distance is less than or equal to, in increasing order of preference, 300 feet, 200 feet, 100 feet, 50 feet, 30 feet, or 25 feet.

Still referring to FIG. 2, a valid key fob in zones E and G which are interior regions of vehicle 38 is required to start the vehicle. A key fob outside the vehicle cabin zones E and G will prevent starting the vehicle.

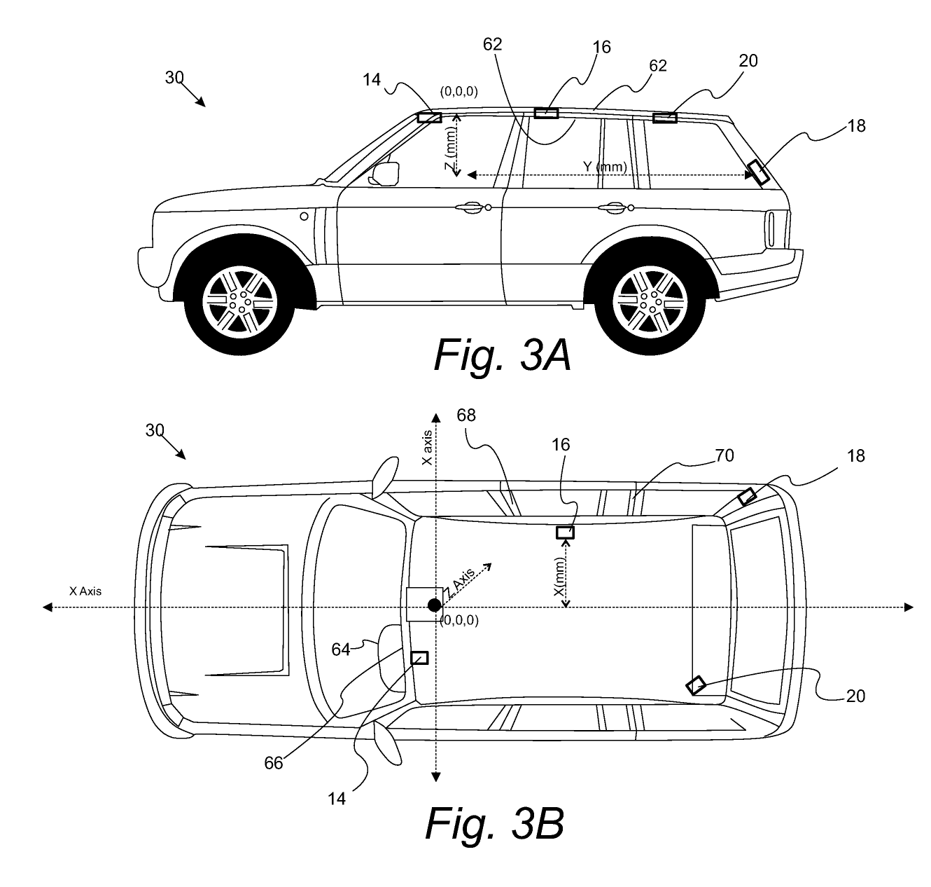

With reference to FIGS. 3A and 3B, schematic illustrations showing the placement of satellite ultra-wideband antenna anchors and, therefore, the ultra-wideband antennas within a vehicle 30 are provided. In this variation, satellite ultra-wideband antenna anchor 14 is positioned in headliner 62 at approximately the middle of the left (or right) side of a sun visor 64 (left or right sun visor) and close to front windshield edge 66, preferably not more than 15 mm from the front windshield edge and more preferably directly adjacent the front windshield edge. In the context of the present invention, the left side is the driver side and the right side is the side opposite the driver side. This positioning helps provide optimum front (driver/passenger) zone coverage. Satellite ultra-wideband antenna anchor 16 is positioned on the opposite side to that of satellite ultra-wideband antenna anchor 14 in the headliner 62 between B pillar 68 and C pillar 70 which are located on the same side of the vehicle. The satellite ultra-wideband antenna anchor 16 is positioned closer to the B pillar 68 than C pillar 70. This positioning of satellite ultra-wideband antenna anchor 16 helps provide back and front seat coverage. Satellite ultra-wideband antenna anchor 18 is positioned at the bottom side of quarter glass 72 on the same side as ultra-wideband antenna anchor 16 on the D pillar 74. This positioning provides the practically possible maximum Z-Axis separation in a vehicle to provide 3D location sensing. Positions below this location degrade the system performance because of the seat and metal clutter. Satellite ultra-wideband antenna anchor 20 is positioned in the roof headliner 62 above the D-pillar 74′ which is on the opposite side of D-Pillar 74, preferably not translated more than 20 mm in either the X- or Y-direction from the top of the D-Pillar. This positioning adds to the optimization of trunk and rear seat area precision.

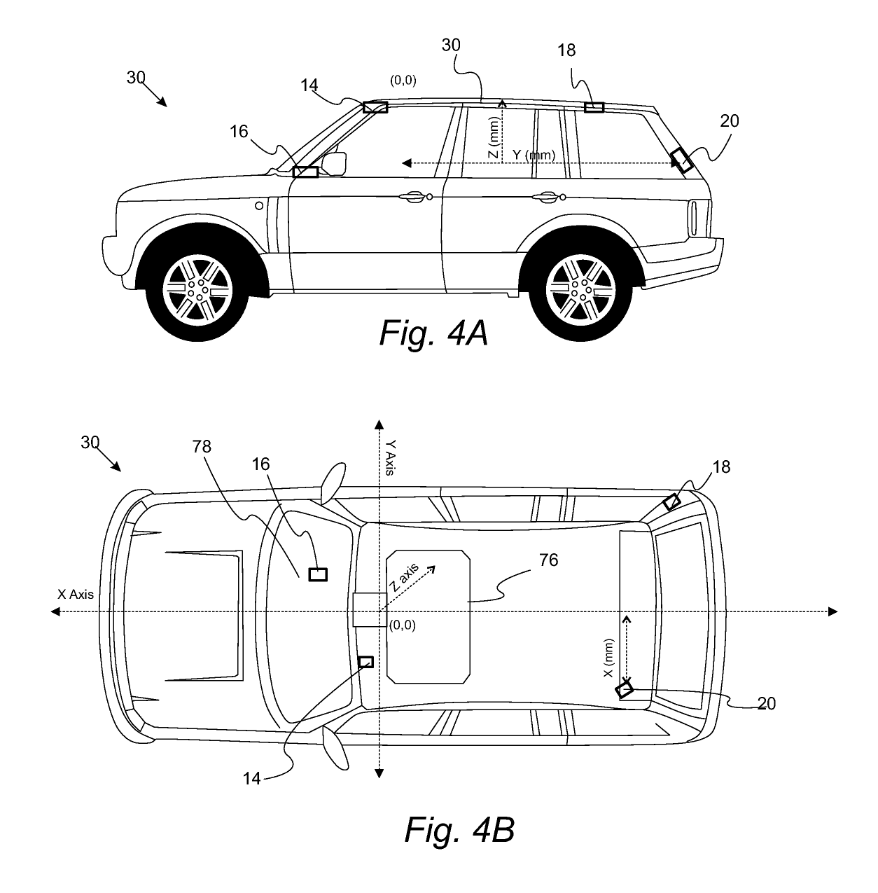

With reference to FIGS. 4A and 4B, a schematic illustration showing the placement of satellite ultra-wideband antenna anchors within vehicle 30 is provided. This variation is particularly useful in vehicles having a moon roof. In such vehicles, the positioning of satellite ultra-wideband antenna anchor 16 depicted in FIGS. 3A and 3B is not practical as it may interfere with the operation of the moon roof 76. Therefore, satellite ultra-wideband antenna anchor 16 is positioned in the dash board area 78 opposite to satellite ultra-wideband antenna anchor 14. It should be appreciated that the dash board antenna would preferably be directly under the non-metallic surface of the dashboard cover and high on the dashboard (preferably on the highest point of the dashboard), so that it can cover cabin areas towards the bottom. Finally, the satellite ultra-wideband antenna 16 should face upwards.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electronic passive entry-passive start (peps) system comprising:
a first satellite ultra-wideband antenna positioned within or on a vehicle;
a second satellite ultra-wideband antenna positioned within or on a vehicle;
a third satellite ultra-wideband antenna positioned within or on a vehicle;
a fourth satellite ultra-wideband antenna positioned within or on a vehicle;
a remote function actuator in electronic communication with the first satellite ultra-wideband antenna, the second satellite ultra-wideband antenna, the third satellite ultra-wideband antenna, and the fourth satellite ultra-wideband antenna; and
a key fob in wireless communication with the first satellite ultra-wideband antenna, the second satellite ultra-wideband antenna, the third satellite ultra-wideband antenna, and the fourth satellite ultra-wideband antenna such that predetermined functions in a vehicle are actuated depending on the position of a user.

2. The system of claim 1 wherein the first satellite ultra-wideband antenna, the second satellite ultra-wideband antenna, the third satellite ultra-wideband antenna, and the fourth satellite ultra-wideband antenna are positioned within a vehicle with a maximum possible separation distance with respect to an axis system in a plane parallel to a vehicle floor.

3. The system of claim 1 wherein at least one ultra-wideband antenna has a maximum separation from other anchors with respect to an axis perpendicular to a plane parallel a vehicle floor.

4. The system of claim 1 operable to open at least one vehicle door when a user with the key fob is within a first predefined distance of a vehicle's B pillar.

5. The system of claim 4 wherein the user with the key fob must be within the first predefined distance in order to remotely start the vehicle.

6. The system of claim 4 operable to open a vehicle trunk when a user with the key fob is within a second predefined distance of a vehicle's trunk.

7. The system of claim 6 wherein the second predefined distance is less than the first predefined distance.

8. The system of claim 1 operable to lock the vehicle when a user with the key fob crosses from a distance less than a third predefined distance to a distance greater than the third predefined distance.

9. The system of claim 8 wherein the third predefined distance is greater than the first predefined distance and the second predefined distance.

10. The system of claim 7 wherein the first satellite ultra-wideband antenna, second satellite ultra-wideband antenna, third satellite ultra-wideband antenna, fourth satellite ultra-wideband antenna, and the key fob transmit and/or receive a signal in the range of 3 kHz to 300 GHz.

11. The system of claim 7 wherein the first satellite ultra-wideband antenna, second satellite ultra-wideband antenna, third satellite ultra-wideband antenna, fourth satellite ultra-wideband antenna, and the key fob transmit and/or receive a signal with a bandwidth greater than or equal to 500 MHz or 20% of a center frequency.

12. An electronic passive entry-passive start (peps) system comprising:
a first satellite ultra-wideband antenna positioned within or on a vehicle;
a second satellite ultra-wideband antenna positioned within or on a vehicle;
a third satellite ultra-wideband antenna positioned within or on a vehicle;
a fourth satellite ultra-wideband antenna positioned within or on a vehicle;
a remote function actuator in electronic communication with the first satellite ultra-wideband antenna, the second satellite ultra-wideband antenna, the third satellite ultra-wideband antenna, and the fourth satellite ultra-wideband antenna;
a body control module in electronic communication with remote function actuator; and
a key fob in wireless communication with the first satellite ultra-wideband antenna, the second satellite ultra-wideband antenna, the third satellite ultra-wideband antenna, and the fourth satellite ultra-wideband antenna such that predetermined functions in a vehicle are actuated depending on the position of a user, wherein the first satellite ultra-wideband antenna, second satellite ultra-wideband antenna, third satellite ultra-wideband antenna, fourth satellite ultra-wideband antenna, and the key fob transmit and/or receive a signal in the range of 3 kHz to 300 GHz and wherein the first satellite ultra-wideband antenna, first satellite ultra-wideband antenna, first satellite ultra-wideband antenna, first satellite ultra-wideband antenna, and the key fob transmit and/or receive a signal with a bandwidth greater than or equal to 500 MHz or 20% of a center frequency.
